(19) United States
(12) Patent Application Publication
(10) Pub. No.: US 2017/0214052 A1
(43) Pub. Date: Jul. 27, 2017

(54) ELECTRODE HAVING NANOCRYSTAL ASSEMBLED ACTIVE CLUSTERS EMBODIED IN CONDUCTIVE NETWORK STRUCTURES, AND BATTERY HAVING SAME, AND FABRICATION METHOD OF SAME

(71) Applicant: Ford Cheer International Limited, Tortola (VG)

(72) Inventor: Jianguo Xu, Pasadena, CA (US)

(21) Appl. No.: 15/408,579

(22) Filed: Jan. 18, 2017

Related U.S. Application Data
(60) Provisional application No. 62/286,632, filed on Jan. 25, 2016.

(51) Int. Cl. H01M 4/62; H01M 4/131; H01M 4/04; C04B 35/52; H01M 4/66; C04B 35/626; C04B 35/634; C04B 35/638; H01M 10/0525; H01M 4/52

(52) U.S. Cl. CPC H01M 4/625; H01M 10/0525; H01M 4/131; H01M 4/0471; H01M 4/0404; H01M 4/0419; H01M 4/52; H01M 4/661; C04B 35/62695; C04B 35/6264; C04B 35/634; C04B 35/638; C04B 35/52; C04B 2235/422; C04B 2235/85; C04B 2235/96

(57) ABSTRACT

In one aspect of the invention relates to an electrode usable for a battery including a conductive network and an active clusters embodied in the conductive network, where the active clusters are of a three-demission (3-D) structure formed of an assembly of nanocrystals, and the nanocrystals are assembled into a carbon skeleton in the active clusters.

### CROSS-REFERENCE TO RELATED PATENT APPLICATION

This application claims priority to and the benefit of, pursuant to 35 U.S.C. §119(e), U.S. Provisional Patent Application Ser. No. 62/286,632, filed Jan. 25, 2016, which is incorporated herein in its entirety by reference.

### FIELD

This present invention relates generally to a method for fabricating anode and cathode active materials for lithium ion batteries, where the active materials are assembled by nanocrystals and further embodied in conductive carbons.

### BACKGROUND

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the present invention.

Rechargeable Li-ion batteries are currently considered as the leading candidates for electric vehicles. Presently, graphite with a theoretical specific capacity of 372 mAh/g has been used as standard anode material because lithium can be stably inserted/deinserted during the repeated charge and discharge processes. However, in order to produce higher energy and power density batteries, it is essential to develop battery electrodes with a high charge/discharge rate, a high reversible capacity, and a low cost.

In addition to graphite, there are several other anode materials, such as lithium metal, a lithium metal alloy, a carbon material, silicon, tin, tin oxide and transition metal oxide, and the likes. When lithium is used, a high capacity can be implemented due to a high energy density. However, dendrite formation due to the strong reducing power of lithium causes problems related to stability. Silicon, tin and their alloys are being studied as alternatives. Specially, silicon undergoes a reversible reaction with lithium and has a theoretical maximum capacity of 4200 mAh g⁻¹, which is greatly higher value compared to that of carbon materials. However, a very great volume change of 200-400% occurs due to the lithium reaction when charging/discharging, thereby causing disastrous capacity fading. To minimize the volume changes, studies on silicon nanowires are made. However, the processes are complicated and the cost is still far from acceptable in commercial applications.

Transition metal oxides of a significantly larger reversible capacity, especially the abundant, low cost and nontoxic Fe₃O₄, and thus hold most promise in electrode materials. However, transition metal oxides typically break into small metal pieces because of their reactions with Li during the Li intercalation mechanism. This usually leads to a large volume expansion and a destruction of the electrode structure upon electrochemical cycling, especially at high rates.

Strategies including reducing the particle size and mixing the particles with various carbon additives, have been employed to improve the reversible capacity and rate capability of metal oxide electrodes. Generally, metal oxide nanoparticles and carbon coated metal oxides are directly mixed with a carbon additive and a binder to help maintain electrical conductivity, and the large volume expansion then results in mechanical degradation of the electrode and thus a low capacity. Recent efforts using graphene or CNT additives have much improved electrode rate capacity; however, the nanocrystals are directly mixed with graphene or CNT additives, thus cycling stability is not satisfactory due to the lack optimization of electroactive materials. Besides, the capacity reported are limited only in thin films (less than 2 micros), thus the specific capacity per area still needs to go for real engineering applications.

Accordingly, a durable, say combing high-rate capability, a high energy density and ultra-stable stability together, for metal oxide based electrodes including Fe₃O₄ are still underway. Synergy of optimizing of electroactive materials and structure design of composite electrodes needs to be considered to endow their corresponding bulk electrodes with high capacity, high rate and excellent stability.

Therefore, a heretofore unaddressed need exists in the art to address the aforementioned deficiencies and inadequacies.

### SUMMARY

In certain aspects, this invention relates to negative and positive electrode materials for lithium ion rechargeable batteries, including hierarchically porous active nanocrystal clusters and the synthesis methods thereof. According to embodiments of the synthesis methods, electrochemically active nanocrystals are dispersed into an aqueous solution, and then carbon sources and surfactants are added into the dispersion to form a mixture of uniform dispersion. The spray granulation is used to condense the dispersion mixture into composite particles under the condition of a temperature about 200-900° C. The collected particles are further treated in a temperature about 400-900° C. under nitrogen, leading to the formation of electrode materials for lithium ion batteries. The electrode materials have a porous structure, and highly conductive carbon networks, which offer effective ion and electron transport channels. Using those electrode materials, the lithium ion batteries have high capacity, large current charge and discharge rates, and high cycle stability. The spray method according to certain embodiments of the invention is suitable for mass production, and can be extended to other kinds of high-performance electrode materials.

In certain aspects, this invention is directed to an effective fabrication of three-dimensional (3-D) Fe₃O₄ clusters towards advanced anode lithium ion electrodes. Special design features have been incorporated in the Fe₃O₄ anodes to combine together the rate performance, the specific capacity, the cycling stability, and the specific per area capacity. As a method, this invention can also be expanded for the fabrication of cathode active materials. This invention will really advance the state of the art of production of battery electrodes.

In one aspect, the active materials are optimized by starting with synthesis of nanocrystals, which shortens the ion diffusion in electro active materials; then, based on the bottom-up design principle, the nanocrystals are assembled into carbon skeleton derived from the decomposition of carbon source using aerosol spraying. This process leads to the formation of 3-D spherical micro particles with an open porous microstructure.

In another aspect, the electrode structure of such electrodes is optimized. Subsequent mixing of those micro particles with CNT solution and filtration produce highly robust and flexible freestanding composite electrodes, where electro active materials are tightly hold in the flexible CNT networks.

In certain aspects, this invention provides the following critical features required for high-performance electrodes: (i) the hierarchically porous Fe₃O₄ cluster provides high charge-storage capacity with shortened lithium diffusion length while the CNT scaffold and carbon skeleton provide fast electron transport pathways; (ii) the network structure and porous channels in Fe₃O₄ clusters create fast ion transport; and (iii) the interpenetrating network of CNTs provides an electrode structure excellent mechanical robustness that accommodates large volume changes.

Further, according to the invention, a scalable potential exists from the following aspects: raw materials being abundant and nontoxic, of low cost; the whole process being facile and the equipment involved in this process being available in present industrial process, thus making these anodes and cathodes highly scalable; and highly unique electrochemical properties.

In one aspect of the invention, the electrode usable for a battery includes a conductive network and an active clusters embodied in the conductive network, wherein the active clusters are of a three-demission (3-D) structure formed of an assembly of nanocrystals, wherein the nanocrystals are assembled into a carbon skeleton in the active clusters.

In one embodiment, an average size of the nanocrystals is about 1-100 nm.

In one embodiment, the nanocrystals comprise nanograins, nanorods, nanoparticles, or a combination thereof.

In one embodiment, an average size of the active clusters is about 100 nm-10 micros.

In one embodiment, the carbon skeleton is formed in the active clusters around the nanocrystals with a thickness about 0.5-5 nm.

In one embodiment, the carbon skeleton is derived from a carbon source, wherein the carbon source comprises direct carbons, organic molecule-derived carbons, or polymer-derived carbons.

In one embodiment, the conductive network is formed of carbon nanofibers, carbon nanotubes, metal nanofibers, conductive composite fibers, or a combination thereof.

In one embodiment, the electrode is an anode, where the active clusters are negative active clusters, and the nanocrystals comprises nanocrystals of Sn, Si, Li, Li, Ti, Ge, Fe₃O₄, SnO₂, TiO₂, CoO₃, Co₃O₄, CuO, In₂O₃, NiO, MoO₃ WO₃, or the like.

In one embodiment, the electrode is a cathode, where the active clusters are positive active clusters, and the nanocrystals comprises nanocrystals of S, Li, LiMn₂O₄, V₂O₅, LiCoO₂, LiFePO₄, Li₃V₂(PO₄)₃, LiMnPO₄, or the like.

In another aspect of the invention, the battery, comprises an anode and a cathode, where one of the anode and cathode includes the electrode as disclosed above.

In yet another aspect of the invention, as shown in FIG. 1, the method for fabricating an electrode usable for a battery includes the following steps.

At step 110, a mixture solution of nanocrystals mixed with a surfactant and a carbon source in an aqueous or organic solution is prepared.

At step 120, active nanocrystal assembled clusters are formed from the mixture solution, where the nanocrystals are assembled into the clusters and embodied in a carbon skeleton derived from the carbon source.

At step 130, an electrode is formed to have the active clusters embodied in a conductive network.

In one embodiment, the step of forming the active nanocrystal assembled clusters is formed by an aerosol spraying process.

In one embodiment, the step of forming the electrode comprises adding the active nanocrystal assembled clusters into a solution containing the conductive network to form a mixture; and homogenously mixing and subsequent filtrating the mixture so as to produce freestanding composite films, wherein the nanocrystals are substantially hold in the conductive networks.

In one embodiment, the method further comprises treating the films in an insert gas to condense the films as the electrode usable for a battery.

In one embodiment, the conductive network is formed of carbon nanofibers, carbon nanotubes, metal nanofibers, conductive composite fibers, or a combination thereof.

In one embodiment, the carbon source comprises direct carbons, organic molecule-derived carbons, or polymer-derived carbons. In one embodiment, the direct carbons comprise carbon black, carbon nanofibers, carbon nanotubes, graphene, graphite, or the like, wherein the organic molecule-derived carbons comprise carbons derived from organic molecules including sugar, glucose, oleic acid, oil amine, or the like, and wherein the polymer-derived carbons comprise carbons derived from polymers including polyamic acid, polymethyl methacrylate, polyamide, or the like.

In one embodiment, the surfactant comprises PVA, PEO, PVP, PVAc, PAA, F127, F123, or kinds of decomposable molecules and polymers that are usable to disperse the nanocrystals and form pores in the active clusters.

In one embodiment, the electrode is an anode of a battery, where the active clusters are negative active clusters, and the nanocrystals comprises nanocrystals of Sn, Si, Li, Li, Ti, Ge, Fe₃O₄, SnO₂, TiO₂, CoO₃, Co₃O₄, CuO, In₂O₃, NiO, MoO₃ WO₃, or the like.

In one embodiment, the electrode is a cathode of a battery, where the active clusters are positive active clusters, and the nanocrystals comprises nanocrystals of S, Li, LiMn₂O₄, V₂O₅, LiCoO₂, LiFePO₄, Li₃V₂(PO₄)₃, LiMnPO₄, or the like.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is schematic of a method for fabricating an electrode usable for a battery according to one embodiment of this invention.

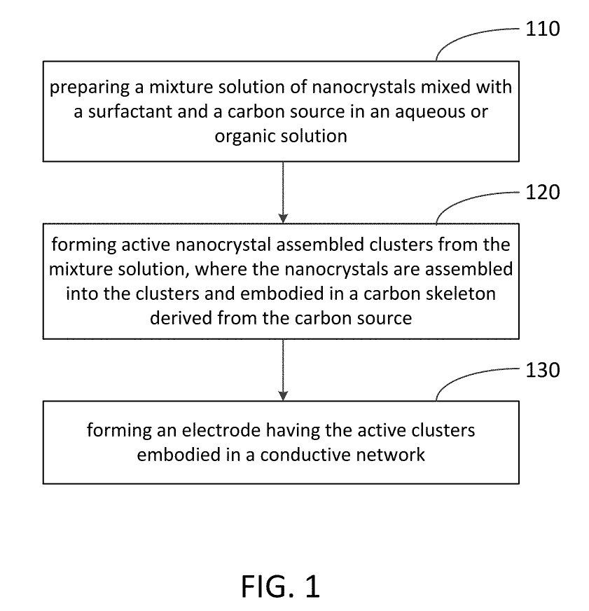

FIG. 2 is schematic of an aerosol process and an apparatus for performing the aerosol process to synthesize active cluster particles according to one embodiment of this invention.

FIG. 3 is a SEM (scanning electron microscope) image of Fe₃O₄ clusters formed by aerosol process using Fe₃O₄ nanocrystals according to one embodiment of this invention.

### DESCRIPTION OF EMBODIMENTS

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top”, may be used herein to describe one element's relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower” can, therefore, encompass both an orientation of “lower” and “upper”, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially” or “approximately” can be inferred if not expressly stated.

As used herein, the terms “comprise” or “comprising”, “include” or “including”, “carry” or “carrying”, “has/have” or “having”, “contain” or “containing”, “involve” or “involving” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the invention.

The description is now made as to the embodiments of the invention in conjunction with the accompanying drawings. In accordance with the purposes of this invention, as embodied and broadly described herein, this invention relates to high-performance electrodes for battery having nanocrystal assembled active cluster embodied in conductive network structures and batteries using the same, and fabrication methods of the active materials for batteries. According to the invention, two levels of structure designs, say the porous nanocrystal assembled active particles and the flexible conductive matrix, endows the anodes and/or cathodes with mechanically robustness, and high-performance electrochemical properties.

In one aspect of the invention, the electrode usable for a battery includes a conductive network and an active clusters embodied in the conductive network, wherein the active clusters are of a three-demission (3-D) structure formed of an assembly of nanocrystals, wherein the nanocrystals are assembled into a carbon skeleton in the active clusters.

In one embodiment, an average size of the nanocrystals is about 1-100 nm.

In one embodiment, the nanocrystals comprise nanograins, nanorods, nanoparticles, or a combination thereof.

In one embodiment, an average size of the active clusters is about 100 nm-10 micros.

In one embodiment, the carbon skeleton is formed in the active clusters around the nanocrystals with a thickness about 0.5-5 nm.

In one embodiment, the carbon skeleton is derived from a carbon source, wherein the carbon source comprises direct carbons, organic molecule-derived carbons, or polymer-derived carbons.

In one embodiment, the conductive network is formed of carbon nanofibers, carbon nanotubes, metal nanofibers, conductive composite fibers, or a combination thereof.

In one embodiment, the electrode is an anode, where the active clusters are negative active clusters, and the nanocrystals comprises nanocrystals of Sn, Si, Li, Li, Ti, Ge, Fe₃O₄, SnO₂, TiO₂, CoO₃, Co₃O₄, CuO, In₂O₃, NiO, MoO₃ WO₃, or the like.

In one embodiment, the electrode is a cathode, where the active clusters are positive active clusters, and the nanocrystals comprises nanocrystals of S, Li, LiMn₂O₄, V₂O₅, LiCoO₂, LiFePO₄, Li₃V₂(PO₄)₃, LiMnPO₄, or the like.

In another aspect of the invention, the battery, comprises an anode and a cathode, where one of the anode and cathode includes the electrode as disclosed above.

In yet another aspect of the invention, the method for fabricating an electrode usable for a battery includes preparing a mixture solution of nanocrystals mixed with a surfactant and a carbon source in an aqueous or organic solution; forming active nanocrystal assembled clusters from the mixture solution, wherein the nanocrystals are assembled into the clusters and embodied in a carbon skeleton derived from the carbon source; and forming an electrode having the active clusters embodied in a conductive network.

In one embodiment, the step of forming the active nanocrystal assembled clusters is formed by an aerosol spraying process.

In one embodiment, the step of forming the electrode comprises adding the active nanocrystal assembled clusters into a solution containing the conductive network to form a mixture; and homogenously mixing and subsequent filtrating the mixture so as to produce freestanding composite films, wherein the nanocrystals are substantially hold in the conductive networks.

In one embodiment, the method further comprises treating the films in an insert gas to condense the films as the electrode usable for a battery.

In one embodiment, the conductive network is formed of carbon nanofibers, carbon nanotubes, metal nanofibers, conductive composite fibers, or a combination thereof.

In one embodiment, the carbon source comprises direct carbons, organic molecule-derived carbons, or polymer-derived carbons. In one embodiment, the direct carbons comprise carbon black, carbon nanofibers, carbon nanotubes, graphene, graphite, or the like, wherein the organic molecule-derived carbons comprise carbons derived from organic molecules including sugar, glucose, oleic acid, oil amine, or the like, and wherein the polymer-derived carbons comprise carbons derived from polymers including polyamic acid, polymethyl methacrylate, polyamide, or the like.

In one embodiment, n the surfactant comprises PVA, PEO, PVP, PVAc, PAA, F127, F123, or kinds of decomposable molecules and polymers that are usable to disperse the nanocrystals and form pores in the active clusters.

In one embodiment, the electrode is an anode of a battery, where the active clusters are negative active clusters, and the nanocrystals comprises nanocrystals of Sn, Si, Li, Li, Ti, Ge, Fe₃O₄, SnO₂, TiO₂, CoO₃, Co₃O₄, CuO, In₂O₃, NiO, MoO₃ WO₃, or the like.

In one embodiment, the electrode is a cathode of a battery, where the active clusters are positive active clusters, and the nanocrystals comprises nanocrystals of S, Li, LiMn₂O₄, V₂O₅, LiCoO₂, LiFePO₄, Li₃V₂(PO₄)₃, LiMnPO₄, or the like.

As one exemplary example, a solution mixing metal oxide nanocrystals, such as Fe₃O₄, a surfactant and a carbon source is prepared, and then is used for aerosol spraying and hot-spraying to form the nanocrystal assembled clusters.

Next, a highly robust and flexible freestanding composite film for a battery electrode is produced by mixing of these active clusters with the CNT solution and filtration, where electroactive materials are tightly hold in the CNT networks. Importantly, the electroactive materials are optimized by the assembly of Fe₃O₄ nanocrystals to form 3-D clusters.

Then the films are annealed in insert gas, which further condenses the films for battery electrodes.

In addition to Fe₃O₄ nanocrystals, nanocrystals usable as negative active materials include, but are not limited to, metal oxides such as Fe₂O₃, SnO₂, TiO₂, CoO₃, Co₃O₄, CuO, In₂O₃, NiO, MoO₃ WO₃, and the like. Further, nanoparticles usable as negative active materials may also include, but are not limited to, nanoparticles of Ti, Si, Ge, and the like. Moreover, nanocrystals usable as cathode active materials further include, but are not limited to, LiMn₂O₄, V₂O₅, LiCoO₂, LiFePO₄, Li₃V₂(PO₄)₃, and the like.

In certain embodiments, the surfactant used as not only for dispersing the particles but also as pore-makers, to form the hierarchical structures of the battery electrodes, includes, but is not limited to, polyvinyl alcohol (PVA), polyethylene (PEO), polyvinylpyrrolidone (PVP), polyvinylacetate (PVAc), polyamic acid (PAA), F127, P123, and the like.

In certain embodiments, the carbon source includes, but is not limited to, sucrose, glucose, organic moleculars and polymers which can be decomposed into carbons, CNT, graphene, graphite, and the likes.

Without intent to limit the scope of the invention, examples and their related results according to the embodiments of the present invention are given below. These examples, however, should not in any sense be interpreted as limiting the scope of the present invention.

### EXAMPLE 1

### Preparation of Aerosol Mixture Solution

A homogenous mixture solution of active nanocrystals, mixed with a surfactant and a carbon source in an aqueous or organic solution is prepared. In certain embodiments, the nanocrystals are the active materials with a short ion diffusion length due to the nanoscale size. The surfactant serves to disperse the nanocrystals as well as the carbon source into an individual state; and also serves to produce the pores in the resulted active materials. The carbon source serves to form the carbon skeleton after aerosol-spraying process, which increases the conductive of the active materials, and also confines the volume changes of the active materials.

The active nanocrystals according to certain embodiments of the invention are nanomaterials obtained from coprecipitation and hydrothermal methods. There is no specific limitation of the preparation method. Other methods such as hydrolysis and high energy milling for producing the nanomaterials can also be utilized to practice the invention. The active materials includes, but are not limited to, a metal oxide, e.g., Fe₃O₄ used as anodes, silicon as anodes, silicon and Fe₃O₄ mixture as anodes, LiMn₂O₄ as cathodes, and the like. There is no limitation of cathodes materials, which also includes the nanocrystals such as LiMn₂O₄, LiFePO₄, and the like.

The surfactant according to certain embodiments of the invention includes at least one of PVA, PEO, PVP, PVAc, PAA, F127, F123, and the like. However, the surfactant is not limited to the above examples and any kinds of decomposable molecules and polymers that can be used to disperse the nanocrystals and form the pores in the resulted particles may be used to practice the present invention.

The carbon sources to carry out the aerosol process according to certain embodiments of the invention are roughly divided into three classes: direct carbons; carbons from carbonization of organic molecules; and carbons from polymers. A direct carbon source according to certain embodiments of the invention includes, but is not limited to, at least one of carbon black, carbon nanofibers, carbon nanotubes, graphene, graphite, and the like. Examples of the organic molecules include, but are not limited to, at least one of sugar, glucose, oleic acid, oil amine, and the like. Examples of the polymers to produce the carbons include, but are not limited to, polyamic acid, polymethyl methacrylate, polyamide, and the like. According to the invention, for the decomposable carbon source, it is necessary to add it into the mixture solution. For the direct carbon, it can be added into the mixture solution in certain embodiments, and in other embodiments, there is no need to add it into the mixture solution.

An example of the preparation process of the aerosol spraying solution is described below in detail. First, FeCl₃ and FeCl₂·4H₂O and aqueous ammonia were put into a three neck flask to produce Fe₃O₄ nanocrystals by coprecipitation. Then, the surfactant and carbon source were added into the solution to prepare a homogenous mixture. In this solution, the nanocrystal weight content is about 0.1-10%; the surfactant is about 1-5%; and the carbon source is about 1-5%; the solvent can be water, organic and inorganic solvent, and their mixtures.

### EXAMPLE 2

### Fabrication of Active Nanocrystal Assembled Clusters

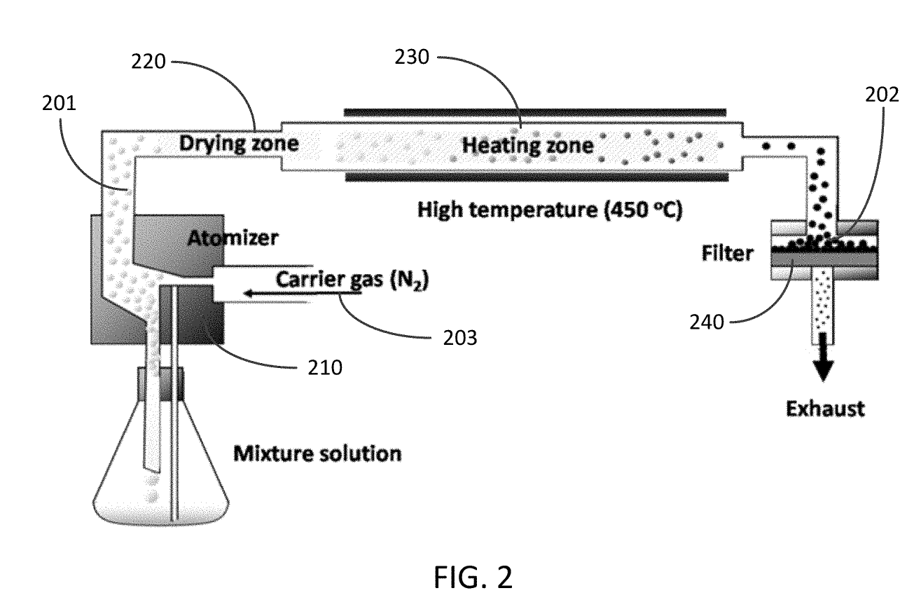

According to certain embodiments of the invention, active porous clusters are obtained by aerosol spraying using an aerosol device. FIG. 2 shows schematically the aerosol process and an apparatus for performing the aerosol process. The apparatus in certain embodiments includes an atomizer 210, a drying zone 220 and a heating zone 230, and a filtration device 240 to collect the active clusters 202. When the carrier gas 203 is input into the atomizer 210, the mixture solution containing nanocrystals (e.g., Fe₃O₄) is pumped into the atomizer 210 and becomes small liquid drops 201. The gas 203 carries the liquid drops 201 into the drying and heating zones 220 and 230, which condense the drops 201, thereby forming the active clusters 202. The active particles 202 are collected at the end of the device 240.

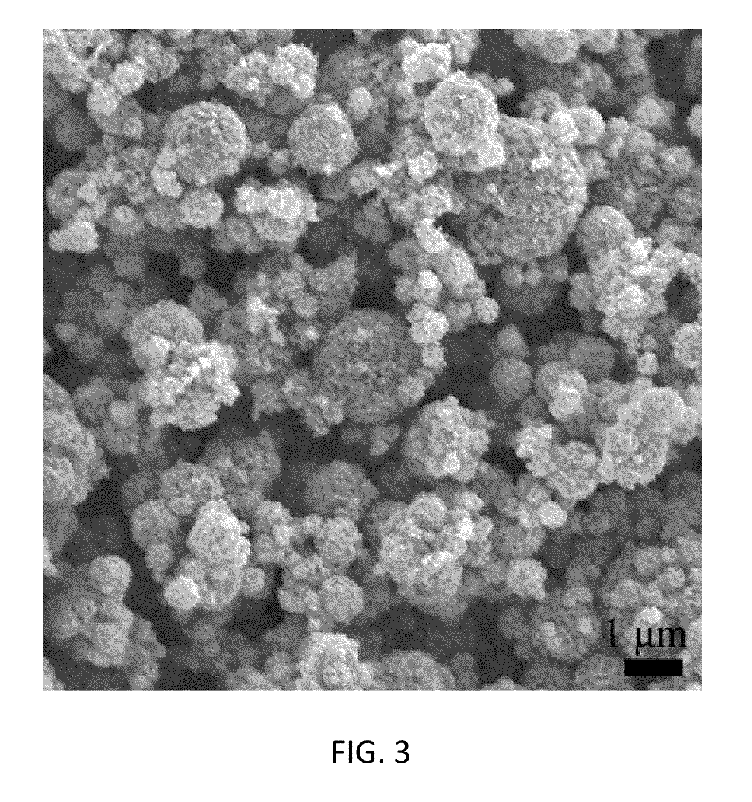

According to the aerosol-spraying, the grain nanocrystals are assembled into clusters, where Fe₃O₄ nanocrystals are embodied in a carbon skeleton that derives from thermal decomposition of the carbon source as shown in FIG. 3. The active Fe₃O₄ elements are about 40-95 wt % in the as-prepared clusters according the mixture content.

### EXAMPLE 3

### Fabrication of Conductive Network Hold Clusters Electrodes

The collected active clusters were added in to a solution containing conductive agents, such as CNT, metal nanofibers, graphene, and the like. A homogenous mixing, subsequent filtration produces freestanding composite films, where electroactive materials are tightly hold in the networks. The film thickness is about 1 micron to about 1 millimeter, facilitating the subsequent operations.

The formed electrodes are further condensed by placing the films in thermal treatments at about 300-800° C. This enhances the networks, thereby enhancing the electrode stability. This structure, with Fe₃O₄ clusters trapped in flexible conductive networks presents a flexible matrix that tolerates the volume changes and prevents the detachment and agglomeration of pulverized Fe₃O₄ particles during cycling of battery electrodes.

Furthermore, the active materials are mixed with carbons or decomposable polymers to form viscous slurries. The slurries are sprayed on the current collectors such as Cu, Al, steel, Ni forms and the like. They are also put into insert gas for decomposition of polymers to form the conductive carbons.

In brief, the invention provides, among other things, the method to prepare high-performance battery electrodes. Critical features required for the high-performance electrodes have been achieved: the hierarchically porous nanocrystal assembled clusters provides high charge-storage capacity with shortened lithium diffusion length while the carbon scaffold and carbon skeleton provide fast electron transport pathways; the network structure and porous channels in Fe₃O₄ clusters create fast ion transport; and the interpenetrating networks of conductive fibers provide electrode structure excellent mechanical robustness that accommodates large volume changes.

Further a scalable potential exists from the following aspects: raw materials are abundant and nontoxic, of low cost; the whole process is facile and the equipment involved in this process are available in present industrial process, thus making this fabrication method highly scalable; and this fabrication method provides highly unique electrochemical properties.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrode usable for a battery, comprising:
a conductive network and an active clusters embodied in the conductive network, wherein the active clusters are of a three-demission (3-D) structure formed of an assembly of nanocrystals, wherein the nanocrystals are assembled into a carbon skeleton in the active clusters.

2. The electrode of claim 1, wherein an average size of the nanocrystals is about 1-100 nm.

3. The electrode of claim 1, wherein the nanocrystals comprise nanograins, nanorods, nanoparticles, or a combination thereof.

4. The electrode of claim 1, wherein an average size of the active clusters is about 100 nm-10 micros.

5. The electrode of claim 1, wherein the carbon skeleton is formed in the active clusters around the nanocrystals with a thickness about 0.5-5 nm.

6. The electrode of claim 5, wherein the carbon skeleton is derived from a carbon source, wherein the carbon source comprises direct carbons, organic molecule-derived carbons, or polymer-derived carbons.

7. The electrode of claim 1, wherein the conductive network is formed of carbon nanofibers, carbon nanotubes, metal nanofibers, conductive composite fibers, or a combination thereof.

8. The electrode of claim 1, being an anode,
wherein the active clusters are negative active clusters; and
wherein the nanocrystals comprises nanocrystals of Sn, Si, Li, Li, Ti, Ge, Fe₃O₄, SnO₂, TiO₂, CoO₃, Co₃O₄, CuO, In₂O₃, NiO, MoO₃ WO₃, or the like.

9. The electrode of claim 1, being a cathode,
wherein the active clusters are positive active clusters; and
wherein the nanocrystals comprises nanocrystals of S, Li, LiMn₂O₄, V₂O₅, LiCoO₂, LiFePO₄, Li₃V₂(PO₄)₃, LiMnPO₄, or the like.

10. A battery, comprising an anode and a cathode, wherein one of the anode and cathode comprises the electrode of claim 1.

11. A method for fabricating an electrode usable for a battery, comprising:
preparing a mixture solution of nanocrystals mixed with a surfactant and a carbon source in an aqueous or organic solution;
forming active nanocrystal assembled clusters from the mixture solution, wherein the nanocrystals are assembled into the clusters and embodied in a carbon skeleton derived from the carbon source; and
forming an electrode having the active clusters embodied in a conductive network.

12. The method of claim 11, wherein the conductive network is formed of carbon nanofibers, carbon nanotubes, metal nanofibers, conductive composite fibers, or a combination thereof.

13. The method of claim 11, wherein the carbon source comprises direct carbons, organic molecule-derived carbons, or polymer-derived carbons.

14. The method of claim 11, wherein the direct carbons comprise carbon black, carbon nanofibers, carbon nanotubes, graphene, graphite, or the like, wherein the organic molecule-derived carbons comprise carbons derived from organic molecules including sugar, glucose, oleic acid, oil amine, or the like, and wherein the polymer-derived carbons comprise carbons derived from polymers including polyamic acid, polymethyl methacrylate, polyamide, or the like.

15. The method of claim 11, wherein the surfactant comprises PVA, PEO, PVP, PVAc, PAA, F127, F123, or kinds of decomposable molecules and polymers that are usable to disperse the nanocrystals and form pores in the active clusters.

16. The method of claim 11, wherein the step of forming the active nanocrystal assembled clusters is formed by an aerosol spraying process.

17. The method of claim 11, wherein the step of forming the electrode comprises:
adding the active nanocrystal assembled clusters into a solution containing the conductive network to form a mixture; and
homogenously mixing and subsequent filtrating the mixture so as to produce freestanding composite films, wherein the nanocrystals are substantially hold in the conductive networks.

18. The method of claim 17, further comprising:
treating the films in an insert gas to condense the films as the electrode usable for a battery.

19. The method of claim 11, wherein the electrode is usable as an anode in a battery,
wherein the active clusters are negative active clusters; and
wherein the nanocrystals comprises nanocrystals of Sn, Si, Li, Ti, Ge, Fe₃O₄, SnO₂, TiO₂, CoO₃, Co₃O₄, CuO, In₂O₃, NiO, MoO₃ WO₃, or the like.

20. The electrode of claim 11, wherein the electrode is usable as a cathode in a battery,
wherein the active clusters are positive active clusters; and
wherein the nanocrystals comprises nanocrystals of S, Li, LiMn₂O₄, V₂O₅, LiCoO₂, LiFePO₄, Li₃V₂(PO₄)₃, LiMnPO₄, or the like.
